(19) United States
(12) Patent Application Publication
(10) Pub. No.: US 2005/0192518 A1
(43) Pub. Date: Sep. 1, 2005

(54) Methods for treating opthalmalogical conditions using micro-acupuncture

(76) Inventor: Per Otte, Hot Springs Village, AR (US)

Correspondence Address: Boyd D. Cox, 75 N. East Avenue, Suite 506, P.O. Box 573, Fayetteville, AR, 72701, US

(21) Appl. No.: 11/054,699

(22) Filed: Feb. 10, 2005

Related U.S. Application Data
(60) Provisional application No. 60/543,946, filed on Feb. 11, 2004.

(51) Int. Cl. A61H 1/02

(52) U.S. Cl. 601/1

(57) ABSTRACT

A method of treating opthalmological conditions, including macular degeneration, myopia, hyperopia, diabetic retinopathy, glaucoma, retinitis pigmentosa and eye floaters in a patient using micro-acupuncture. The method includes the steps of placing needles in the patient at key trigger points for a prescribed period of time and then removing the needles.

Priority for this application is claimed from U.S. Provisional Application No. 60/543,946 entitled “Methods For Treating Opthalmalogical Conditions Using Micro-Acupuncture” filed on Feb. 11, 2004

### BACKGROUND

The present invention is directed to a method of micro-acupuncture for treating a patient suffering from at least one or more opthalmological conditions. The opthalmological conditions include macular degeneration, myopia, hyperopia, diabetic retinopathy, glaucoma, retinitis pigmentosa and eye floaters. The treatment comprises inserting needles in key trigger points on at least one of the patient's hands and at least one foot for a prescribed period of time, then removing the needles. The micro-acupuncture treatment of the present invention significantly relieves the patient's symptoms of macular degeneration, myopia, hyperopia, diabetic retinopathy, glaucoma, retinitis pigmentosa and/or eye floaters.

### SUMMARY

The present invention is directed to a micro-acupuncture method for treating patients suffering from opthalmalogical conditions, including macular degeneration, myopia, hyperopia, diabetic retinopathy, glaucoma, retinitis pigmentosa and/or eye floaters and for reducing the symptoms thereof.

The method of treatment comprises the steps of placing needles in the patient at particular key trigger points, leaving the needles in place for at least approximately 20 minutes, then removing the needles from the patient. Subsequent treatments can be provided over the course of a specified time period, such as days or weeks.

It is an object of the present invention to provide a method for treating one or more opthalmological conditions in a patient using micro-acupuncture.

It is a further object of the present invention to provide a method for treating macular degeneration in a patient.

It is a further object of the present invention to provide a method for treating myopia in a patient.

It is a further object of the present invention to provide a method for treating hyperopia in a patient.

It is a further object of the present invention to provide a method for treating diabetic retinopathy in a patient.

It is a further object of the present invention to provide a method for treating glaucoma in a patient.

It is a further object of the present invention to provide a method for treating retinitis pigmentosa in a patient.

It is a further object of the present invention to provide a method for treating eye floaters in a patient.

It is a further object of the present invention to provide a method for significantly reducing the symptoms of opthalmalogical conditions using acupuncture techniques.

It is a further object of the present invention to provide a method for significantly reducing the symptoms of macular degeneration in a patient.

It is a further object of the present invention to provide a method of acupuncture treatment for significantly reducing the symptoms of myopia in a patient.

It is a further object of the present invention to provide a method of acupuncture treatment that significantly reduces the symptoms of hyperopia in a patient.

It is a further object of the present invention to provide a method of acupuncture to treat diabetic retinopathy that significantly reduces the symptoms thereof in a patient.

It is a further object of the present invention to provide a method of acupuncture for treating glaucoma that significantly reduces the symptoms thereof in a patient.

It is a further object of the present invention to provide a method of acupuncture for treating retinitis pigmentosa that significantly reduces the symptoms thereof in a patient.

It is a further object of the present invention to provide a method of acupuncture for treating eye floaters that significantly reduces the symptoms thereof in a patient.

It is a further object of the present invention to provide a method of acupuncture treatment that improves the vision of a patient.

It is a further object of the present invention to provide a micro-acupuncture method of treating opthalmalogical conditions including macular degeneration, myopia, hyperopia, diabetic retinopathy, glaucoma, retinitis pigmentosa and eye floaters.

### BRIEF DESCRIPTION OF THE DRAWINGS

Reference is made to the accompanying drawings in which are shown illustrative embodiments of the invention and from which novel features and advantages will be apparent.

FIG. 1 is a schematic of the bottoms of a patient's feet showing the key trigger points for needle placement in a first preferred embodiment of the present invention.

FIG. 2 is a schematic of the palm side of a patient's hands, showing the key trigger points for needle placement in the embodiment of FIG. 1.

FIG. 3 is a schematic of a patient's feet and hands with the needles placed at the key trigger points of FIGS. 1 and 2.

FIG. 4 is a schematic of a patient's foot and hand showing the key trigger points for needle placement in a second preferred embodiment of the present invention.

FIG. 5 is a schematic of a patient's foot and hand with the needles placed at the key trigger points in the embodiment of FIG. 4.

FIG. 6 is a schematic of a patient's foot and hands showing the key trigger points for needle placement in a third preferred embodiment of the present invention.

FIG. 7 is a schematic of a patient's foot and hands with needles placed at the key trigger points in the embodiment of FIG. 6.

FIG. 8 is a schematic of a patient's feet and hand showing the key trigger points for needle placement in a fourth preferred embodiment of the present invention.

FIG. 9 is a schematic of a patient's feet and hand with needles placed at the key trigger points in the embodiment of FIG. 8.

### DETAILED DESCRIPTION

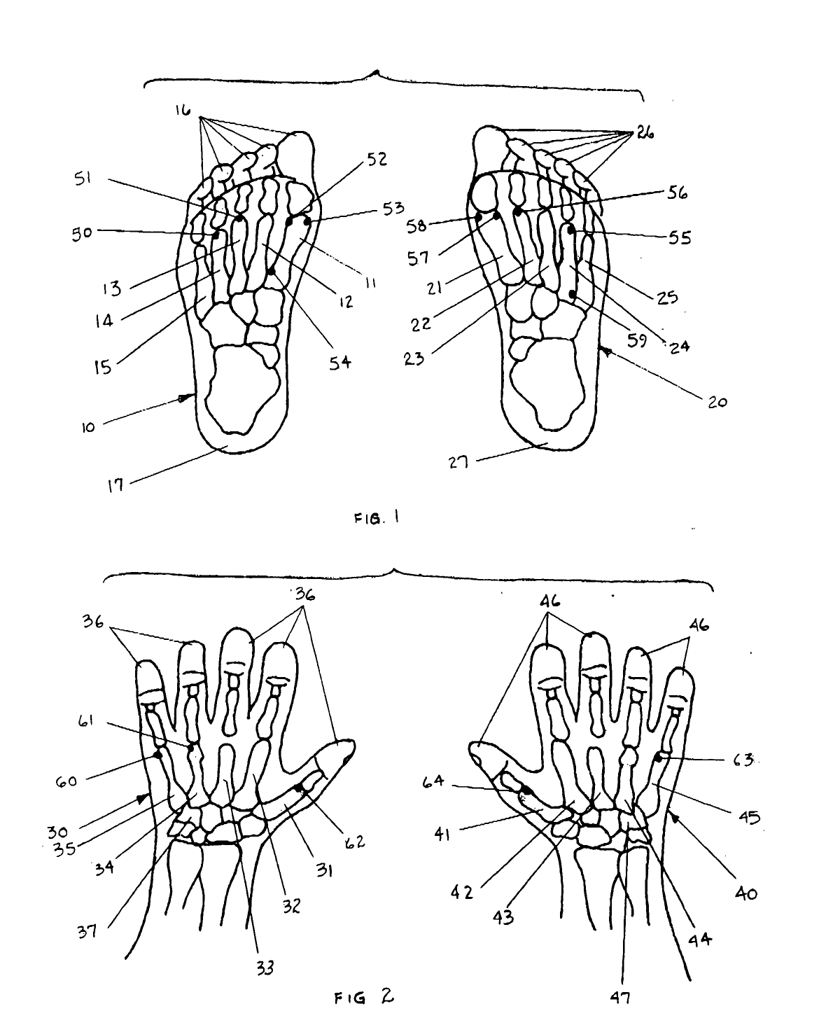

Referring now to FIG. 1, there is shown a schematic diagram of the bottom of both of a patient's feet 10 and 20. In the figures, the foot at 10 can be either the left or the right foot of the patient and the foot at 20 is the other of the left or right foot. Each foot 10 and 20 has metatarsals, including a first metatarsal 11 and 21, a second metatarsal 12 and 22, a third metatarsal 13 and 23, a fourth metatarsal 14 and 24, and a fifth metatarsal 15 and 25. Each metatarsal 11-15 and 21-25 has a distal end and a proximal end. The distal ends are located closer to the digits 16 and 26 of each respective foot 10 and 20 and the proximal ends are located closer to the heel 17 and 27 of each respective foot 10 and 20. Each metatarsal 11-15 and 21-25 is further distinguished as having an inner side and an outer side. The inner side of each metatarsal 11-15 and 21-25 is disposed closer to an edge of the respective foot aligned with the first metatarsal 11 and 21. The outer side is disposed on a side of the metatarsal 11-15 and 21-25 opposite the inner side and is closer to the edge of the respective foot aligned with the fifth metatarsal 15 and 25.

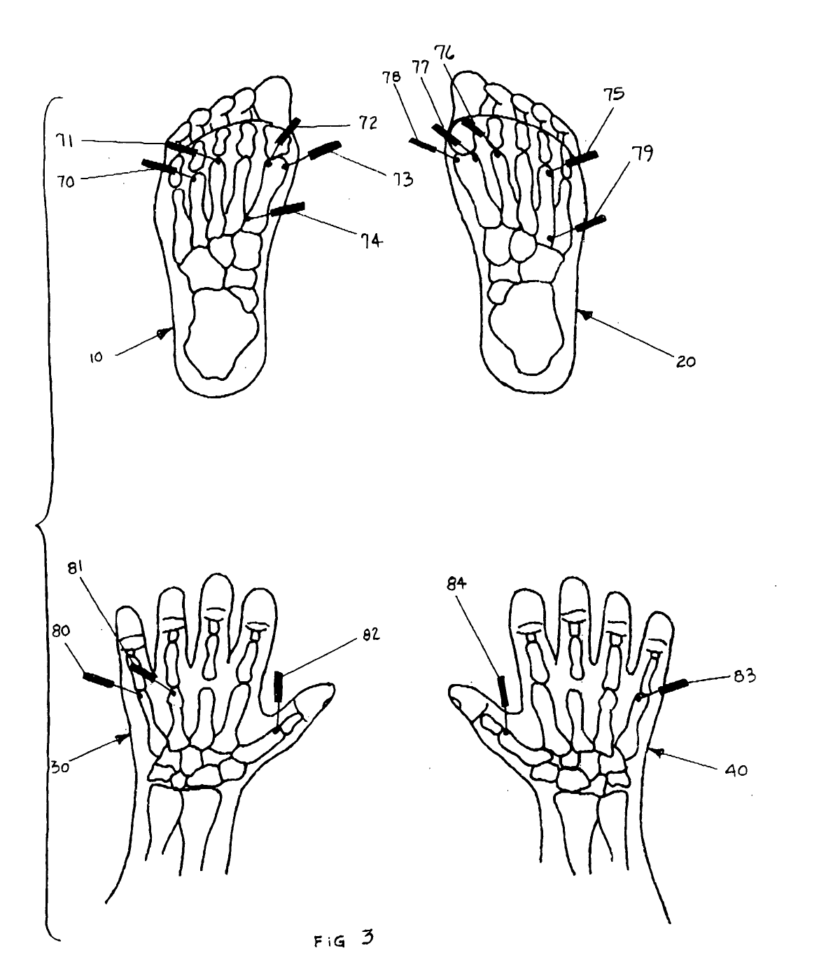

Referring now to FIG. 2, there is shown a schematic diagram of the palm side of each of a patient's left and right hands 30 and 40 having five metacarpals 31-35 and 41-45, including respective first metacarpals 31 and 41, second metacarpals 32 and 42, third metacarpals 33 and 43, fourth metacarpals 34 and 44, and fifth metacarpals 35 and 45. In the figures, the hand at 30 can be either the left or right hand of the patient and the hand at 40 is the other of the left or right hand. Each metacarpal 31-35 and 41-45 has a distal end and a proximal end. The distal ends are disposed nearer to the respective digits 36, 46 of the hands 30 and 40 and the proximal ends are disposed closer to the heel 37 and 47 of the hands. Each metacarpal 31-35 and 41-45 is further distinguished as having an inner side and an outer side. The inner side of each metacarpal 31-35 and 41-45 is disposed closer to an edge of the respective hand 30 and 40 aligned with its respective first metacarpal 31 and 41. The outer side of each metacarpal 31-35 and 41-45 is disposed closer to an edge of the respective hand 30 and 40 aligned with its respective fifth metacarpal 35 and 45.

In a first preferred embodiment of the present invention in FIGS. 1 and 2, there are five key trigger points used in each foot 10 and 20 as shown in FIG. 1. The key trigger points in the feet at 10 and 20 are indicated with reference numerals as follows: GB/A at 50, KI/A at 51, LI/A at 52, SP/A at 53, LI/B at 54 on one foot at 10, and GB/A at 55, ST/A at 56, LI/A at 57, SP/A at 58 and GB/B at 59 on the other foot at 20.

The key trigger points of each respective foot 10 and 20 have the following described locations. On the foot 10, the key trigger point GB/A 50 is located at an outer side of a distal end of the fourth metatarsal 14, while KI/A 51 is located in the middle of the third metatarsal 13 at a distal end thereof The point LI/A 52 is located at an outer side of the distal end of the first metatarsal 11. The point SP/A 53 is located at an inner side near the distal end of the first metatarsal 11. LI/B 54 is located at an outer side near the proximal end of the first metatarsal 11.

On the other foot 20, GB/A 55 is located on an outer side of the distal end of the fourth metatarsal 24. ST/A 56 is located proximate the middle of the distal end of the second metatarsal 22. The key trigger point LI/A 57 is on the outer side of the first metatarsal 21 at a distal end thereof. SP/A 58 is on the distal end of the first metatarsal 21 on the inner side thereof. Key trigger point GB/B 59 is on the proximal end of the fourth metatarsal 24 on an outer side thereof. The designated key trigger points on one foot are interchangeable with the key trigger points on the other foot, so that the points on a particular foot can be alternated, if desired. That is, one designated set of key trigger points can be used effectively on one of the patient's right and left feet, while the other set of designated key trigger points can be used effectively on the patient's other foot, such that the designated sets of key trigger points can be interchanged between the right and left feet.

In the hands 30 and 40, as shown in FIG. 2, there are five key trigger points 60-64 included in the present invention. These points are indicated by reference numerals as follows: SI/A at 60, E/A at 61, LU/A at 62 in one hand 30 and H/A at 63 and LU/A at 64 in the other hand 40.

The locations of the key trigger points on the hands 30 and 40 are as follows. The point SI/A 60 is located adjacent an outer side of the hand 30 on the distal end of the fifth metacarpal 35. The key trigger point E/A 61 is on the distal end of the fourth metacarpal 34 adjacent the outer side thereof. Trigger point LU/A 62 is located on the distal end of the first metacarpal 31 on an outer side thereof. On the opposing hand 40, the point H/A 63 is positioned on the distal end of the fifth metacarpal 45 on an inner side thereof. The trigger point LU/A 64 is on an outer side of the distal end of the first metacarpal 41.

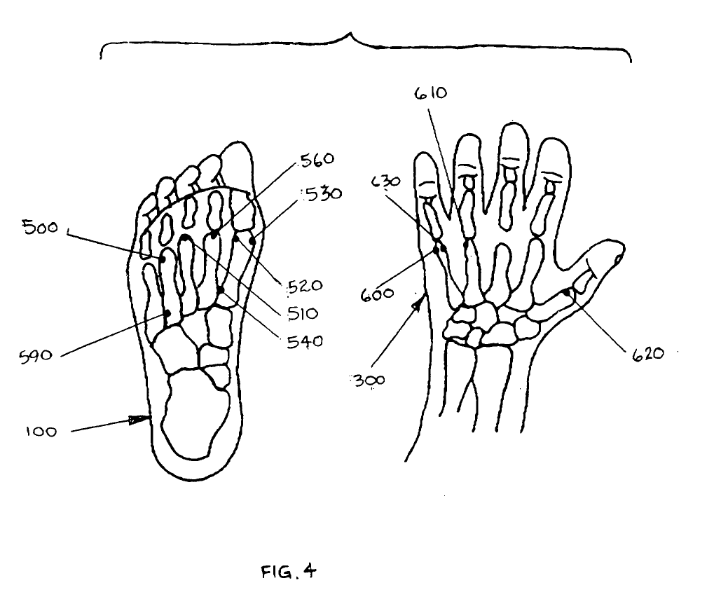

Referring to FIG. 3, the configuration of the needle placement in the hands 10,20 and feet 30,40 is shown for the first preferred embodiment of the present invention. In this embodiment, needles 70-74 are placed in foot 10 at the respective key trigger points GB/A 50, KI/A 51, LI/A 52, SP/A 53 and LI/B 54 and needles 75-79 are placed in the other foot 20 of the patient at the respective key trigger points GB/A 55, ST/A 56, LI/A 57, SP/A 58 and GB/B 59. The needles 80-82 are placed in hand 30 at the respective key trigger points SI/A 60, E/A 61, and LU/A 62. Needles 83 and 84 are placed in the other hand 40 at the respective key trigger points H/A 63 and LU/A 64.

In the first preferred embodiment of the present invention, the designated sets of key trigger points 60-62 and 63-64 can be interchanged between the left and right hands. For example, in a treatment, the key trigger points 60-62 can be used on either the patient's right or left hand, while the points 63-64 are used in the patient's other hand. The sets of designated key trigger points 50-54 and 55-59 are also interchangeable between the left and right feet of the patient. Consequently, the present invention comprises treatments that include all of the possible combinations of the sets of designated key trigger points 50-54 and 55-59 on the respective left and right feet and the key trigger points 60-62 and 63-64 on the respective left and right hands.

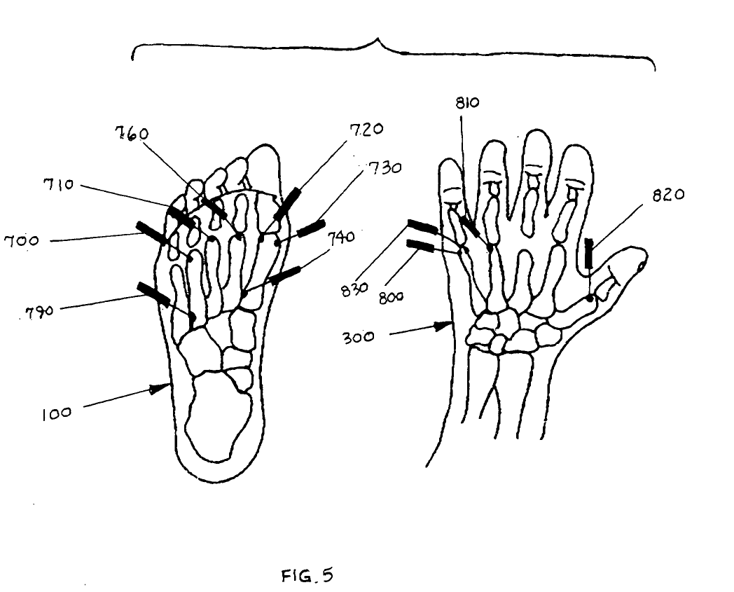

In a second preferred embodiment of the present invention for treating macular degeneration, diabetic retinopathy, glaucoma, myopia, hyperopia, retinitis pigmentosa and eye floaters, the key trigger points are located on one foot 100 and one hand 300 as shown in FIG. 4. The foot at 100 and hand at 300 can be either the left or right foot and either the left or right hand, respectively. The key trigger points in the foot 100 include GB/A 500, KI/A 510, LI/A 520, SP/A 530, LI/B 540, ST/A 560 and GB/B 590. The key trigger points in the hand 300 include SI/A 600, E/A 610, LU/A 620, and H/A 630.

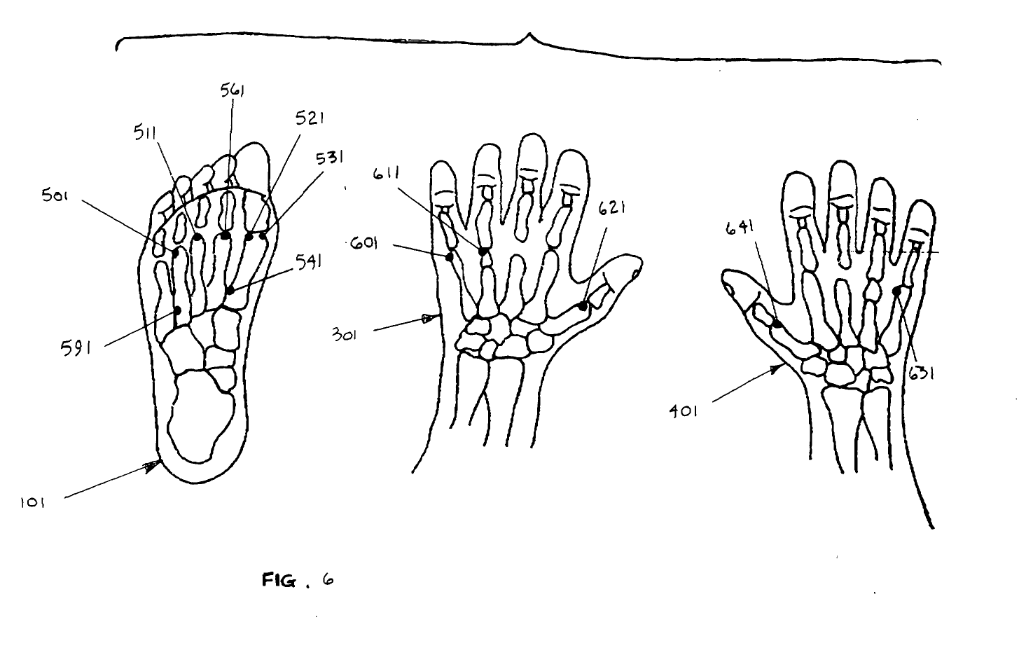

Referring also to FIG. 5 showing needle placement of the second preferred embodiment, needles 700, 710, 720, 730, 740, 760 and 790 are placed in the foot 100 at the respective key trigger points GB/A 500, KI/A 510, LI/A 520, SP/A 530, LI/B 540, ST/A 560 and GB/B 590. Additional needles 800, 810, 820 and 830 are placed in the hand 300 at the respective key trigger points SI/A 600, E/A 610, LU/A 620 and H/A 630. In the second embodiment, designated key trigger points of the hand can be in either the left or right hand and the designated key trigger points of the foot can be in either the left or right foot for each treatment. The second preferred embodiment includes all of the possible combinations for treatment using the left or right foot and the left or right hand.

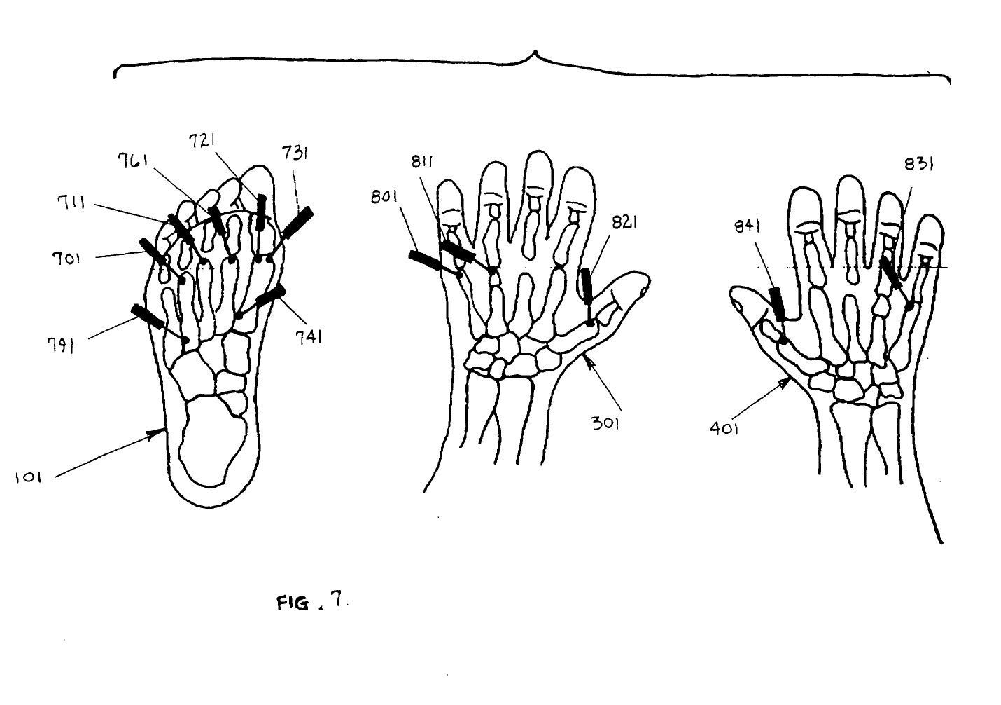

In a third preferred embodiment of the present invention for treating macular degeneration, diabetic retinopathy, glaucoma, myopia, hyperopia, retinitis pigmentosa and eye floaters, the key trigger points are located on one foot and both hands of the patient as shown in FIG. 6. The foot at 101 can be either the left or right foot of the patient. Hand 301 can be one of the left and right hands of the patient, while the hand at 401 is the other hand. In the foot 101, the key trigger points coincide with the locations of the key trigger points on the metatarsals shown in the second embodiment and include GB/A 501, KI/A 511, LI/A 521, SP/A 531, LI/B 541, ST/A 561 and GB/B 591. The key trigger points in the hands 301 and 401 coincide with the key trigger points on the hands 30 and 40 of the first preferred embodiment. The key trigger points on the hand 301 comprise SI/A 601, E/A 611 and LU/A 621 while the key trigger points on the other hand 401 comprise H/A 631 and LU/A 641.

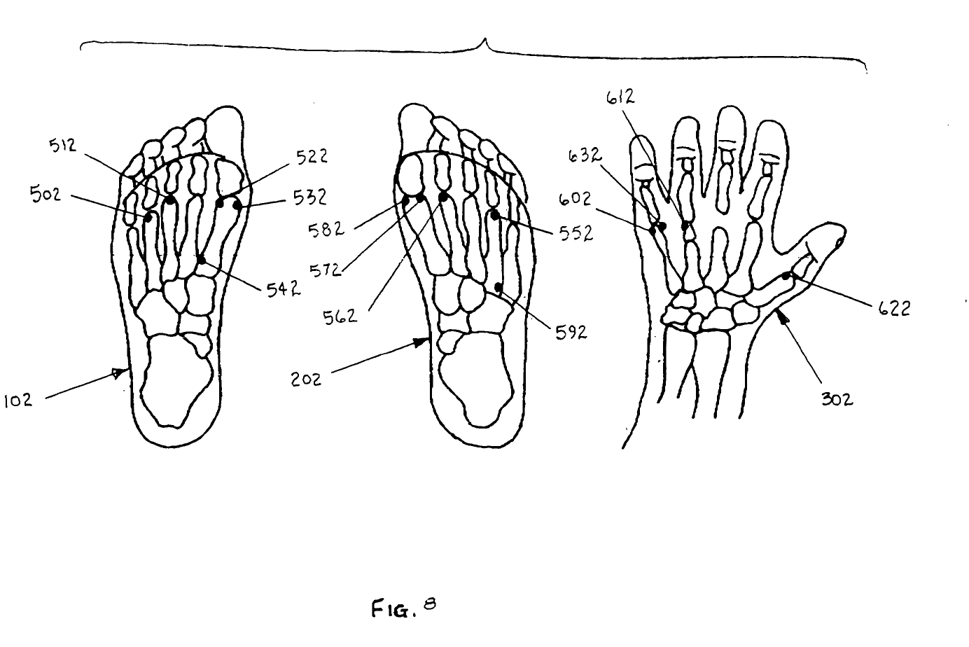

FIG. 7 shows the needles 701, 711, 721, 731, 741, 761 and 791 placed in the respective key trigger points GB/A 501, KI/A 511, LI/A 521, SP/A 531, LI/B 541, ST/A 561 and GB/B 591 on the foot 101, and the needles 801, 811, 821, 831 and 841 placed in the respective key trigger points SI/A 601, E/A 611, LU/A 621, H/A 631 and LU/A 641 on the hands 301 and 401 during the treatment. Again, the key trigger points for the foot can be used on either the left or right foot while the designated key trigger points for each hand are interchangeable between the left and right hands. The present invention includes all of the possible combinations of the sets of designated key trigger points on the left and right hands and on the left and right feet.

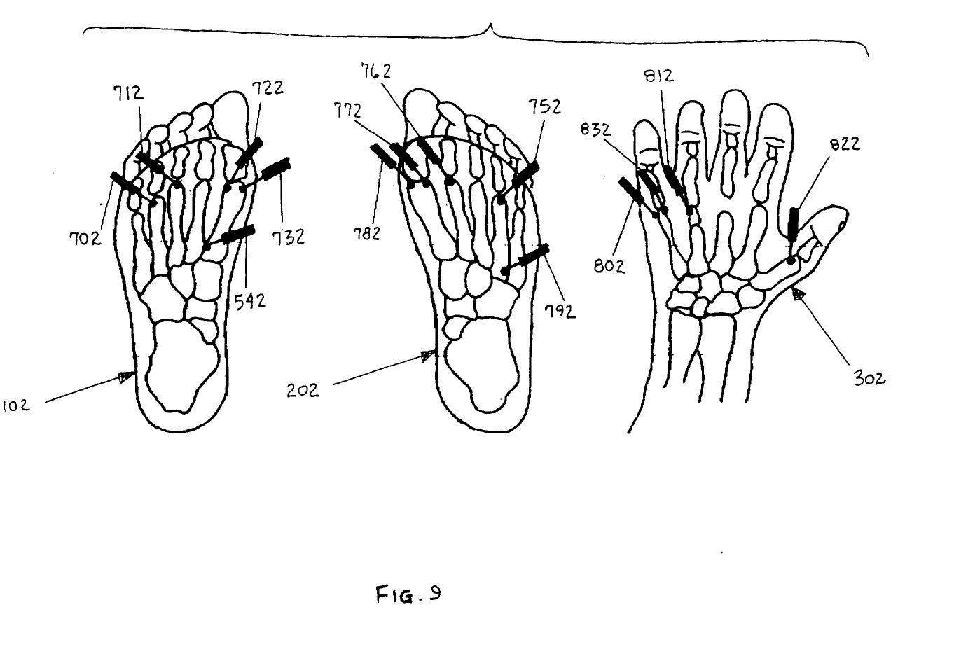

In a fourth preferred embodiment of the present invention shown in FIGS. 8 and 9 for treating macular degeneration, diabetic retinopathy, glaucoma, myopia, hyperopia, retinitis pigmentosa and eye floaters, the key trigger points are located on two feet and one hand of the patient. Foot 102 can be either the left or right foot of the patient, while foot 202 is the other of the left and right foot. The hand at 302 can be either the left or right hand of the patient.

The key trigger points in the foot 102 coincide with the key trigger points in the feet 10, 20 of the first preferred embodiment. The key trigger points of one foot 102 include GB/A 502, KI/A 512, LI/A 522, SP/A 532, LI/B 542 and the key trigger points for the other foot 202 include GB/A 552, ST/A 562, LI/A 572, SP/A 582 and GB/B 592. The key trigger points of the hand 302 coincide with those key trigger points of the hand 301 in the second preferred embodiment. The key trigger points on the hand 302 include SI/A 602, E/A 612, LU/A 622 and H/A 632. The needles 802, 812, 822 and 832 are placed in the respective key trigger points SI/A 602, E/A 612, LU/A 622 and H/A 632 on the hand 302, while needles 702, 712, 722, 732, 742, 752, 762, 772, 782 and 792 are placed in the respective key trigger points GB/A 502, KI/A 512, LI/A 522, SP/A 532, LI/B 542, GB/A 552, ST/A 562, LI/A 572, SP/A 582 and GB/B 592. As with the other embodiments, the designated key trigger points for the feet 102 and 202 are interchangeable between the left foot and the right foot and the key trigger points for the hand 302 can be in either the left or right hand of the patient. Therefore, the fourth embodiment also includes all of the possible combinations of the interchangeable sets of key trigger points in the feet and hands.

In the method of micro-acupuncture for treating opthalmalogical conditions for each of the preferred embodiments of the present invention, the patient undergoing the treatment is preferably placed in a generally horizontal position with feet and hands exposed. The needles are placed in the designated key trigger points on the foot or feet and hand or hands. The needles are left in the key trigger points for a period of time, with the patient relaxed in the generally horizontal position. After the period of time has elapsed, the needles are removed from the patient.

Subsequent treatments can be administered in a series as needed for each of the preferred embodiments. The subsequent treatments include the following steps: (1) after performing the method of treating, waiting for an amount of time to elapse after a treatment; (2) selecting a treatment from one of the preferred embodiments; (3) following the steps of the selected embodiment after the amount of time has elapsed from the previous treatment. These three steps may be repeated as desired. Subsequent treatments in a series of treatments can be given over a course of time. The amount of time to elapse after a treatment in a series of treatments includes at least one or more days and one or more weeks.

In the first embodiment of the present invention, the method for treating at least one opthalmalogical condition including macular degeneration, diabetic retinopathy, myopia, hyperopia, glaucoma, retinitis pigmentosa and eye floaters comprises the steps of placing needles 70-79 and 80-84 at the key trigger points 50-59 and 60-64 in the respective feet 10 and 20 and hands 30 and 40 of a patient as shown in FIGS. 1, 2 and 3; waiting for a period of time of at least about 20 minutes; and removing the needles 70-79 and 80-84.

The steps for the method of treating comprise inserting needles 70-79 and 80-84 into the respective key trigger points GB/A 50, KI/A 51, LI/A 52, SP/A 53 and LI/B 54 on one of the left and right feet 10 and 20 and the respective key trigger points GB/A 55, ST/A 56, LI/A 57, SP/A 58 and GB/B 59 on the other of the left and right feet 10 and 20, the respective key trigger points at SI/A 60, E/A 61 and LU/A 62 on one of the left and right hands 30 and 40, and the respective key trigger points at H/A 63 and LU/A 64 on the other of the left and right hands 30 and 40. After the needles 70-79 and 80-84 have been inserted, the step of waiting for a period of time equal to about 20 minutes is performed. When the period of time has elapsed, the needles 70-79 and 80-84 are removed from the patient's feet and hands.

In the second preferred embodiment shown in FIGS. 4 and 5, the method for treating at least one of the opthalmalogical conditions comprises inserting the needles at the respective key trigger points in either the left or right foot 100 of the patient and in the respective key trigger points of one of the patient's hands 300, waiting for a period of time, and removing the needles.

The method comprises the steps of inserting the needles 700, 710, 720, 730, 740, 760 and 790 into the respective key trigger points GB/A 500, KI/A 510, LI/A 520, SP/A 530, LI/B 540, ST/A 560 and GB/B 590 on either of the patient's left or right feet 100 and inserting the needles 800, 810, 820 and 830 into the respective key trigger points SI/A 600, E/A 610, LU/A 620 and H/A 630 in either of the patient's left or right hands 100; waiting for a period of time of about at least 20 minutes to elapse with the needles inserted; and removing the needles from the patient.

In the third preferred embodiment shown in FIGS. 6 and 7, the method comprises the steps of inserting a needle into each of the respective key trigger points on one foot 101 and both hands 301, 401; waiting a period of time; and removing the needles from the patient's foot and hands. Specifically, the method of treating comprises the following steps: inserting the needles 701, 711, 721, 731, 741, 761, 791, 801, 811, 821, 831 and 841 into the respective key trigger points at GB/A 501, KI/A 511, LI/A 521, SP/A 531, LI/B 541, ST/A 561, GB/B 591 in one of the left and right feet 101, the respective key trigger points at SI/A 601, E/A 611 and LU/A 621 in one of the left and right hands 301 and 401, and the respective key trigger points at H/A 631 and LU/A 641 in the other of the left and right hands 301 and 401; waiting for a period of time equal to at least about 20 minutes with the needles inserted; and removing the needles from the patient.

In the fourth preferred embodiment shown in FIGS. 8 and 9, the method of treating comprises inserting a needle into each of the respective key trigger points of both feet 102, 202 and one hand 302; waiting a period of time; and removing the needles. The method of treating comprises the following steps: inserting the needles 702, 712, 722, 732, 742, 752, 762, 772, 782 792, 802, 812, 822 and 832 into the respective key trigger points at GB/A 502, KI/A 512, LI/A 522, SP/A 532 and LI/B 542 in one of the left and right feet 102 and 202, the respective key trigger points at GB/A 552, ST/A 562, LI/A 572, SP/A 582, and GB/B 592 in the other of the left and right feet 102 and 202, and the respective key trigger points at SI/A 602, E/A 612, LU/A 622 and H/A 632 in either of the left or right hands 302; waiting for a period of time equal to approximately at least 20 minutes; and removing the needles from the patient.

In each of the embodiments disclosed herein, the method further can include a series of treatments provided for each patient. Subsequent treatments in the series would comprise waiting an amount of time, then repeating the steps which comprise inserting the needles into the key trigger points of the patient as specified in the particular embodiment, waiting for a period of time of approximately 20 minutes; and removing the needles in the patient's hand or hands and foot or feet. The frequency of repeated treatments generally occurs over an amount of time. When performing a series of treatments, each treatment in the series can comprise any one of the preferred embodiments as selected by the user and the amount of time is at least one day or at least one week.

The order in which the needles are inserted into the key trigger points for treating the opthalmalogical conditions can be varied. Likewise, the order in which the needles are removed from the patient in each of the embodiments of the invention can be varied also.

It should also be appreciated that various needles and equivalents known in the art can be used to perform the treatments comprising the preferred embodiments of the present invention.

The vision of a patient can be improved with the micro-acupuncture methods of the present invention. By treating certain opthalmalogical conditions with these methods, the symptoms of macular degeneration, myopia, hyperopia, diabetic retinopathy, glaucoma, retinitis pigmentosa and/or eye floaters can be significantly reduced.

Although the present invention has been described in considerable detail with reference to certain preferred versions thereof, other versions are possible. Therefore, the spirit and scope of the appended claims should not be limited to the description of the preferred versions contained herein.

1. A method for treating opthalmalogical conditions in a patient comprising the steps of:
(1) inserting a plurality of needles in respective key trigger points on left and right hands and feet of the patient;
(2) waiting a period of time; and
(3) removing the plurality of needles from the patient;
wherein the respective key trigger points include GB/A located at an outer, distal end of a fourth metatarsal on bottom side of one of the left and right feet; KI/A located proximate a middle of a distal end of a third metatarsal on the bottom side of said one foot; LI/A located at an outer, distal end of a first metatarsal on the bottom side of said one foot; SP/A located at an inner, distal end of the first metatarsal on the bottom side of said one foot; LI/B located at an outer proximal end of the first metatarsal on the bottom side of said one foot; GB/B located at an outer, proximal end of a fourth metatarsal on a bottom side of an other of said left and right feet; GB/A located at an outer, distal end of the fourth metatarsal on the bottom side of said other foot; ST/A located proximate a middle of a distal end of a second metatarsal on the bottom side of said other foot; LI/A located at an outer, distal end of a first metatarsal on the bottom side of said other foot; SP/A located at an inner, distal end of the first metatarsal on the bottom side of said other foot; SI/A located at an outer, distal end of a fifth metacarpal on a palm side of one of the left and right hands of said patient; E/A located at an outer, distal end of a fourth metacarpal on the palm side of said one hand; LU/A located at an outer, distal end of the first metacarpal on the palm side of said one hand; H/A located at an inner, distal end of a fifth metacarpal on a palm side of an other of said left and right hands of said patient; and LU/A located at an outer, distal end of a first metacarpal on a palm side of said other hand.

2. The method of claim 1, wherein the opthalmalogical conditions comprise macular degeneration, myopia, hyperopia, diabetic retinopathy, glaucoma, retinitis pigmentosa and eye floaters.

3. The method of claim 1, wherein said period of time comprises approximately 20 minutes.

4. The method of claim 1, further comprising the additional steps of:
waiting an amount of time; and
repeating steps (1) through (3).

5. The method of claim 4, wherein said amount of time comprises at least one day.

6. The method of claim 5, wherein the opthalmalogical conditions comprise macular degeneration, myopia, hyperopia, diabetic retinopathy, glaucoma, retinitis pigmentosa and eye floaters and said period of time comprises approximately 20 minutes.

7. A method of treating opthalmalogical conditions in a patient comprising the steps of:
(1) inserting a plurality of needles in respective key trigger points on a hand and foot of the patient;
(2) waiting a period of time; and
(3) removing the plurality of needles from the patient;
wherein said key trigger points on a bottom side of one of a patient's left and right feet comprise GB/A located at an outer, distal end of a fourth metatarsal; KI/A located proximate a middle, distal end of a third metatarsal; ST/A located proximate a middle, distal end of a second metatarsal; LI/A located at an outer, distal end of a first metatarsal; SP/A located at an inner, distal end of the first metatarsal; LI/B located at an outer, proximal end of the first metatarsal; and GB/B located at an outer, proximal end of the fourth metatarsal; and
wherein said key trigger points on a palm side of one of a patient's left and right hands comprise SI/A located at an outer, distal end of a fifth metacarpal; H/A located at an inner, distal end of the fifth metacarpal; E/A located at an outer, distal end of a fourth metacarpal; and LU/A located at an outer, distal end of a first metacarpal.

8. The method of claim 7, wherein the opthalmalogical conditions comprise, macular degeneration, myopia, hyperopia, diabetic retinopathy, glaucoma, retinitis pigmentosa and eye floaters.

9. The method of claim 7, wherein said period of time comprises approximately 20 minutes.

10. The method of claim 7, further comprising the additional steps of:
waiting an amount of time; and
repeating steps (1) through (3).

11. The method of claim 10, wherein said amount of time comprises at least a day.

12. The method of claim 11, wherein the opthalmalogical conditions comprise macular degeneration, myopia, hyperopia, diabetic retinopathy, glaucoma, retinitis pigmentosa and eye floaters and said period of time comprises approximately 20 minutes.

13. A method of treating opthalmalogical conditions in a patient comprising the steps of:
(1) inserting a plurality of needles in respective key trigger points on a left foot, a right foot and one hand of the patient;
(2) waiting a period of time; and
(3) removing the plurality of needles from the patient;
wherein the respective key trigger points include GB/A located at an outer, distal end of a fourth metatarsal on bottom side of one of the left and right feet; KI/A located proximate a middle of a distal end of a third metatarsal on the bottom side of said one foot; LI/A located at an outer, distal end of a first metatarsal on the bottom side of said one foot; SP/A located at an inner, distal end of the first metatarsal on the bottom side of said one foot; LI/B located at an inner, proximal end of the fourth metatarsal on the bottom side of said one foot; GB/B located at an outer, proximal end of a fourth metatarsal on a bottom side of an other of said left and right feet; GB/A located at an outer, distal end of the fourth metatarsal on the bottom side of said other foot; ST/A located proximate a middle of a distal end of a second metatarsal on the bottom side of said other foot; LI/A located at an outer, distal end of a first metatarsal on the bottom side of said other foot; SP/A located at an inner distal end of the fist metatarsal on the bottom side of said other foot; and
wherein said key trigger points on a palm side of one of a left and right hands comprise SI/A located at an outer, distal end of a fifth metacarpal; H/A located at an inner, distal end of the fifth metacarpal; 3E/A located at an outer, distal end of a fourth metacarpal; and LU/A located at an outer distal end of a first metacarpal.

14. The method of claim 13, wherein said opthalmalogical conditions comprise macular degeneration, myopia, hyperopia, diabetic retinopathy, glaucoma, retinitis pigmentosa and eye floaters.

15. The method of claim 12, wherein said period of time comprises approximately 20 minutes.

16. The method of claim 12, further comprising the additional steps of:
waiting an amount of time; and
repeating steps (1) through (3).

17. The method of claim 15, wherein said amount of time comprises at least one day.

18. The method of claim 16, wherein said opthalmalogical conditions comprise macular degeneration, myopia, hyperopia, diabetic retinopathy, glaucoma, retinitis pigmentosa and eye floaters and said period of time comprises approximately 20 minutes.

19. A method of treating an opthalmalogical condition in a patient comprising the steps of:
(1) inserting a plurality of needles in respective key trigger points on a left hand, a right hand and one foot of the patient;
(2) waiting a period of time; and
(3) removing the plurality of needles from the patient;
wherein said key trigger points on a bottom side of one of a patient's left and right feet comprise GB/A located at an outer, distal end of a fourth metatarsal; KI/A located proximate a middle, distal end of a third metatarsal; ST/A located proximate a middle, distal end of a second metatarsal; LI/A located at an outer, distal end of a first metatarsal; SP/A located at an inner, distal end of the first metatarsal; LI/B located at an outer, proximal end of the first metatarsal; and GB/B located at an outer, proximal end of the fourth metatarsal; and
wherein said key trigger points on the left and right hands of the patient comprise SI/A located at an outer, distal end of a fifth metacarpal on a palm side of one of the left and right hands of said patient; 3E/A located at an outer, distal end of a fourth metacarpal on the palm side of said one hand; LU/A located at an outer, distal end of the first metacarpal on the palm side of said one hand; H/A located at an inner, distal end of a fifth metacarpal on a palm side of an other of said left and right hands of said patient; and LU/A located at an outer, distal end of a first metacarpal on the palm side of said other hand.

20. The method of claim 19, wherein said opthalmalogical conditions comprise macular degeneration, myopia, hyperopia, diabetic retinopathy, glaucoma, retinitis pigmentosa and eye floaters.

21. The method of claim 19, wherein said period of time comprises approximately 20 minutes.

22. The method of claim 19, further comprising the additional steps of:
waiting an amount of time; and
repeating steps (1) through (3).

23. The method of claim 22, wherein the amount of time comprises at least one day.

24. The method of claim 23, wherein the opthalmalogical condition comprises macular degeneration, myopia, hyperopia, diabetic retinopathy, glaucoma, retinitis pigmentosa and eye floaters and said period of time comprises approximately 20 minutes.
